(19) United States
(12) Patent Application Publication
(10) Pub. No.: US 2024/0246296 A1
(43) Pub. Date: Jul. 25, 2024

(54) Method and Device for Preprocessing Three-dimensional Printing Data, and Digital Operation Platform

(71) Applicant: GUANGZHOU HEYGEARS IMC. INC, Guangzhou (CN)

(72) Inventors: Wei FENG, Guangzhou (CN); Yong WANG, Guangzhou (CN); Ming LI, Guangzhou (CN)

(21) Appl. No.: 18/628,662

(22) Filed: Apr. 5, 2024

Related U.S. Application Data
(63) Continuation of application No. PCT/CN2022/124213, filed on Oct. 9, 2022.

(30) Foreign Application Priority Data
Oct. 11, 2021 (CN) 202111180042.4

(51) Int. Cl. B29C 64/386; B29L 31/00; B33Y 50/00; B33Y 80/00

(52) U.S. Cl. CPC B29C 64/386; B33Y 50/00; B33Y 80/00; B29L 2031/7536

(57) ABSTRACT

The disclosure provides a method and device for preprocessing three-dimensional printing data, and a digital operation platform, and relates to the technical field of rapid prototyping. The method for preprocessing three-dimensional printing data includes: obtaining a three-dimensional design model and a three-dimensional application type corresponding to the three-dimensional design model; matching a corresponding preset processing flow according to the three-dimensional application type; and performing data preprocessing on the three-dimensional design model according to the preset processing flow to obtain a preprocessed three-dimensional design model. The method may achieve the technical effects of reducing labor costs and improving user experience.

### CROSS-REFERENCE TO RELATED APPLICATION

The disclosure is a continuation of the PCT International Application No. PCT/CN2022/124213 filed on Oct. 9, 2022, which claims the priority to Chinese Patent Application No. 202111180042.4, filed to the Chinese Patent Office on Oct. 11, 2021 and entitled “Method and device for preprocessing three-dimensional printing data, and digital operation platform”, which is incorporated in its entirety herein by reference.

### TECHNICAL FIELD

The disclosure relates to the technical field of rapid prototyping, and particularly relates to a method and device for preprocessing three-dimensional printing data, and a digital operation platform.

### BACKGROUND

As the science and technology information develops, the manufacturing technology, the digital modeling technology, the materials science, the numerical control technology, etc. have been boosted to rapidly develop and integrated with each other. The computer technology has been increasingly applied to various aspects of teaching, scientific research and clinical applications in various fields of medicine, and cooperate with these aspects closely. With the development and popularization of the measurement technology, digital dental models, crucial to dental clinical diagnosis and treatment, are easily available. The 3D printing technology has become a current hot topic since its emergence and development, and has been more commonly applied to the medical field. Application of 3D printing to the medical field is dated back to twenty years ago in widespread surgeries including oral implants, orthopedics and neurosurgery.

In the prior art, data preprocessing for a dental model is required in all current application scenes of dental diagnosis and treatment, and occupies most of the time of 3D teeth printing. Preliminary data processing for a dental model, such as model straightening, typesetting, hollowing out, support adding, and slicing are required. All these steps are manually performed, resulting in huge labor costs, heavy workloads and low productive efficiency. In order to improve the efficiency of an entire diagnosis and treatment process, reduce labor costs, and increase the user experience, it is necessary to shorten data processing time and production and processing time of a dental model.

### SUMMARY

Some embodiments of the disclosure provide a method for preprocessing three-dimensional printing data and a digital operation platform, which may implement an automatic processing flow of 3D printing data preprocessing, shorten data processing time and production and processing time of a model, and achieve technical effects of reducing labor costs and improving user experience.

In a first aspect, an embodiment of the disclosure provides a method for preprocessing three-dimensional printing data, including:
obtaining an initial three-dimensional design model and a three-dimensional application type corresponding to the initial three-dimensional design model;
matching a corresponding preset processing flow according to the three-dimensional application type; and
performing data preprocessing on the initial three-dimensional design model according to the preset processing flow to obtain a preprocessed three-dimensional design model.

In the above implementation process, when the initial three-dimensional design model is processed through the method for preprocessing three-dimensional printing data, automatic processing is performed according to the preset processing flow corresponding to the three-dimensional application type, flows of different three-dimensional applications are solved according to different processing modes, and preset processing flows may be added or deleted according to different requirements. For example, in the dental field, preset processing flows include automatic repairing, automatic straightening, automatic hollowing out, automatic typesetting, automatic support adding, gum line identifying, automatic editing, surface texture processing, simulating, jig adding, etc. Therefore, an integrated and automated generation processing flow for different applications provided in the method provides an intelligent system combining a three-dimensional (3D) printing technology and an artificial intelligence algorithm, which may greatly improve the three-dimensional model processing and operation efficiency, reduce a manual processing time, and provide better user experience and product advantages. Thus, the method may implement an automatic processing flow of 3D printing data preprocessing, shorten the data processing time and production and processing time of a model, and achieve the technical effects of reducing the labor costs and improving the user experience.

In an embodiment, the matching a corresponding preset processing flow according to the three-dimensional application type, comprising:
automatic processing is performed according to the preset processing flow corresponding to the three-dimensional application type, flows of different three-dimensional application types are corresponding to different processing modes, and the preset processing flows may be added or deleted according to different requirements; wherein preset processing flow includes at least one of automatic repairing, automatic straightening, automatic hollowing out, automatic typesetting, automatic support adding, gum line identifying and jig adding.

The method is applied to the field of dental field, an initial three-dimensional design model is a dental design model, and a three-dimensional application type is a dental application type; a model contour feature is recognized to identify the dental application type corresponding to the dental design model; corresponding dental application type and the preset processing flow are scheduled to perform data processing.

In a second aspect, an embodiment of the disclosure provides a device for preprocessing three-dimensional printing data, including:
an obtaining unit configured to obtain an initial three-dimensional design model and a three-dimensional application type corresponding to the initial three-dimensional design model;
a matching unit configured to match a corresponding preset processing flow according to the three-dimensional application type; and
a preprocessing unit configured to perform data preprocessing on the initial three-dimensional design model according to the preset processing flow to obtain a preprocessed three-dimensional design model.

In a third aspect, an embodiment of the disclosure provides an electronic apparatus, including a memory, a processor, and a computer program stored on the memory and runnable on the processor, where the processor implements steps of the method according to any one of embodiments in the first aspect when executing the computer program.

In a fourth aspect, an embodiment of the disclosure provides a non-transitory non-transitory computer-readable storage medium, storing an instruction, when the instruction runs on a computer, the computer executes the method according to any one of embodiments in the first aspect.

In a fifth aspect, an embodiment of the disclosure provides a digital operation platform, including a user side, a design side and a preliminary processing unit, where
the user side is configured to collect three-dimensional scanning data and order information of a target;
the design side is configured to receive the three-dimensional scanning data and the order information, and generate an initial three-dimensional design model according to the three-dimensional scanning data; and
the preliminary processing unit is configured to generate three-dimensional printing data according to the method for preprocessing three-dimensional printing data according to any one of embodiments in the first aspect.

In a sixth aspect, an embodiment of the disclosure provides a digital operation platform, including a user side, a design side and a preliminary processing unit, where
the user side is configured to obtain three-dimensional scanning data of a target;
the design side is configured to receive the three-dimensional scanning data and generate an initial three-dimensional design model according to the three-dimensional scanning data; and
the preliminary processing unit is configured to generate a preprocessed three-dimensional design model according to the above method for preprocessing three-dimensional printing data.

In a seventh aspect, an embodiment of the disclosure provides a computer program product. When the computer program product runs on a computer, the computer executes the method according to any one of embodiments in the first aspect.

Additional features and advantages disclosed in the disclosure will be set forth in the following specification, or, some features and advantages is inferred or undoubtedly ascertained from the specification, or is learned by practicing the above-described techniques disclosed herein.

In order to make the above objectives, features and advantages of the disclosure more obvious and understandable, preferred examples will be described in detail below in conjunction with the accompanying drawings.

### BRIEF DESCRIPTION OF THE DRAWINGS

To describe the technical solutions in the examples of the disclosure more clearly, the accompanying drawings required in the examples of the disclosure will be briefly described below. It should be understood that the following accompanying drawings show merely some examples of the disclosure and are therefore not to be considered as limiting the scope, and those of ordinary skill in the art may still derive other related accompanying drawings from these accompanying drawings without making creative efforts.

FIG. 1 is a first schematic flowchart of a method for preprocessing three-dimensional printing data according to an embodiment of the disclosure;

FIG. 2 is a second schematic flowchart of a method for preprocessing three-dimensional printing data according to an embodiment of the disclosure;

FIG. 3 is a third schematic flowchart of a method for preprocessing three-dimensional printing data according to an embodiment of the disclosure;

FIG. 4 is a schematic flowchart of steps of obtaining a repaired three-dimensional model according to an embodiment of the disclosure;

FIG. 5 is a schematic flowchart of steps of straightening a three-dimensional design model according to an embodiment of the disclosure;

FIG. 6 is a schematic flowchart of steps of determining a largest plane of an initial three-dimensional design model according to an embodiment of the disclosure;

FIG. 7 is a schematic flowchart of steps of hollowing out an initial three-dimensional design model according to an embodiment of the disclosure;

FIG. 8 is a schematic flowchart of steps of typesetting according to an embodiment of the disclosure;

FIG. 9 is a schematic flowchart of steps of support adding according to an embodiment of the disclosure;

FIG. 10 is a schematic flowchart of steps of editing according to an embodiment of the disclosure;

FIG. 11 is a schematic structural diagram of a defective three-dimensional design model according to an embodiment of the disclosure;

FIG. 12 is a schematic structural diagram of a repaired three-dimensional model according to an embodiment of the disclosure;

FIG. 13 is a schematic structural diagram of a straightened repaired three-dimensional model according to an embodiment of the disclosure;

FIG. 14 is a schematic structural diagram of a hollowed three-dimensional model according to an embodiment of the disclosure;

FIG. 15 is a sectional view of a hollowed three-dimensional model according to an embodiment of the disclosure;

FIG. 16 is a schematic structural diagram of a hollowed three-dimensional model, a bottom plate and meshes according to an embodiment of the disclosure;

FIG. 17 is a schematic structural diagram of a typeset three-dimensional model according to an embodiment of the disclosure;

FIG. 18 is a structural side view of a typeset three-dimensional model according to an embodiment of the disclosure;

FIG. 19 is a structural block diagram of a device for preprocessing three-dimensional printing data according to an embodiment of the disclosure;

FIG. 20 is a structural block diagram of a digital operation platform according to an embodiment of the disclosure; and

FIG. 21 is a structural block diagram of an electronic apparatus according to an embodiment of the disclosure.

Reference numerals: 100—obtaining unit; 200—matching unit; 300—preprocessing unit; 400—generation unit; 10—three-dimensional design model; 11—defect; 12—repaired three-dimensional model; 13—hollowed three-dimensional model; 14—bottom plate; 15—mesh; 16—typeset three-dimensional model; 17—prototyping surface; 18—support structure; 19—prototyping bottom plate; 21—user side; 22—design side; 23—preliminary processing unit; 24—production side; 25—printing apparatus; 510—processor; 520—communication interface; 530—memory; and 540—communication bus.

### DETAILED DESCRIPTION OF THE EMBODIMENTS

The technical solutions of examples of the disclosure will be described below in conjunction with accompanying drawings of the examples of the disclosure.

It should be noted that similar numerals and letters denote similar items in the following accompanying drawings, and therefore, once an item is defined in one accompanying drawing, it need not be further defined and explained in the subsequent accompanying drawings. Moreover, in the description of the disclosure, the terms “first”, “second”, etc. are used merely to distinguish between descriptions and may not be understood as indication or implication of relative importance.

Examples of the disclosure provide a method for preprocessing three-dimensional printing data and a digital operation platform, which is applied to a three-dimensional (3D) printing technology, for example, model printing in the fields of dentistry, orthopedics, earphone, etc. When a three-dimensional design model is processed through the method for preprocessing three-dimensional printing data, automatic processing is performed according to the preset processing flow corresponding to the three-dimensional application type, flows of different three-dimensional applications are solved according to different processing modes, and preset processing flows may be added or deleted according to different requirements. For example, in the dental field, preset processing flows include automatic repairing, automatic straightening, automatic hollowing, automatic typesetting, automatic support adding, gum line identifying, etc. Therefore, an integrated and automated generation processing flow for different applications provided in the method provides an intelligent system combining a 3D printing technology and an artificial intelligence algorithm, which may greatly improve the three-dimensional model processing and operation efficiency, reduce a manual processing time, and provide better user experience and product advantages. Thus, the method may implement an automatic processing flow of 3D printing data preprocessing, shorten data processing time and production and processing time of a model, and achieve the technical effects of reducing labor costs and improving user experience.

In an embodiment, the method for preprocessing three-dimensional printing data is applied to a dental field, the three-dimensional design model is a dental design model, and the three-dimensional application type is a dental application type.

It should be noted that the method for preprocessing three-dimensional printing data provided in the example of the disclosure is mainly described by taking the dental field as an instance, and does not mean that it is only applicable to the dental field. Based on the same logic and processing flow, and the method for preprocessing three-dimensional printing data may also be applied to fields such as orthopedics, earphone, etc., which will not be repeated herein to avoid repetition.

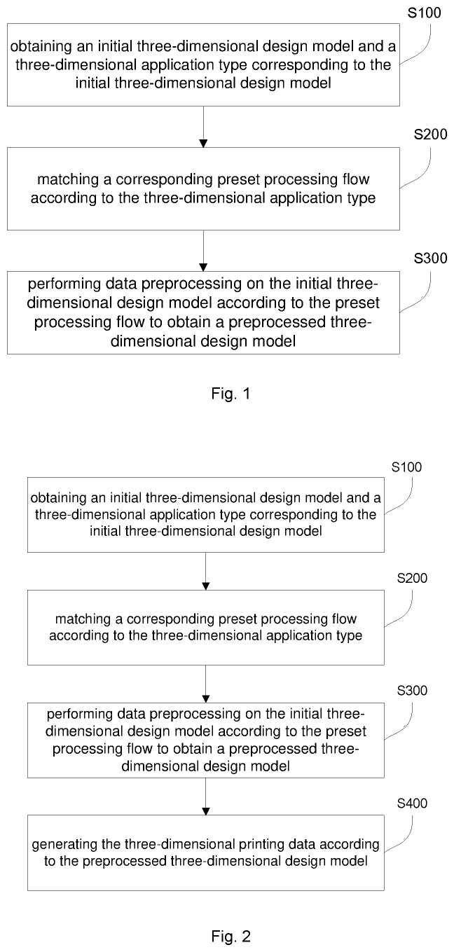

With reference to FIG. 1, FIG. 1 is a schematic flowchart of a method for preprocessing three-dimensional printing data according to an embodiment of the disclosure. The method for preprocessing three-dimensional printing data includes:
S100: obtaining an initial three-dimensional design model and a three-dimensional application type corresponding to the initial three-dimensional design model.

The three-dimensional application type is a category of a product corresponding to the model, and also is an application field of the product. For example, the three-dimensional application type is ear wearable product application type, rehabilitation brace application type, medical instrument application type, industrial product application type, jewelry application type, PVC figure application type, handicraft application type, dental application type, etc.
S200: matching a corresponding preset processing flow according to the three-dimensional application type.

Specifically, for different three-dimensional application types, the corresponding preset processing flows are different or not. In an embodiment, when applied to the dental field, the initial three-dimensional design model is a dental design model, and the three-dimensional application type is a dental application type. Specifically, the dental application types include a temporary crown, a die dental model, an orthodontic model, a guide, a temporary crown and bridge, a baseplate, a tray, an occlusal splint, a gum glue, a wax crown, a study model, a denture, a transparent baseplate, a trial denture, a wax bracket, a fixed prosthesis, a removable prosthetic dental model, an indirect bonding guide, and an implant model. The orthodontic model includes an invisible orthodontic dental model. Alternatively, the dental design model is a design model obtained through a 3D dental treatment solution, that is, a model processed by design software. The input dental design model is in any orientation. In the example, other arbitrary dental design model types with planes do not influence the implementation of the disclosure. A data preprocessing flow includes any one or any combination of the following flows: structure detecting, repairing, straightening, editing, hollowing out, typesetting, surface texture processing, support adding, simulating, slicing, gum line identifying, marking, punching and jig adding. The structure detecting includes detection of prototyping process specifically including a minimum wall thickness, a model detail or surface texture exceed a pre-set resolution, an inverted cup structure, a super large screen, a large solid body, a right-angle edge, a straight hypotenuse, etc., and further includes detection of defects specifically including a defective patch, hole, housing, non-manifold edge, etc. The repairing is configured to repair a defect in the initial three-dimensional design model, and includes normal repairing, flipped surface repairing, housing repairing, non-manifold edge repairing, self-intersecting surface repairing, degenerate surface repairing, duplicate surface repairing, etc. The straightening is configured to adjust an orientation of the initial three-dimensional design model to a preset direction. The editing is configured to split the model and add connectors to the split models, such that the split models are connected together after printing. The hollowing out is configured to adjust a solid model to a hollowed model. The typesetting is configured to arrange the initial three-dimensional design model as much as possible on a design layout corresponding to a printing platform (also called molding platform). The surface texture processing is configured to add or configure a surface texture and material to the initial three-dimensional design model, and the surface texture is customized or preset. The support adding is configured to prevent printing failure caused by falling during printing of a printed part. The simulating is a static mechanical simulation used for layer-by-layer prototyping and peeling processes, to predict possible anomalies (such as falling and fracture), and may also be configured to simulate animation of a prototyping process, to reflect an actual effect, such as laminated striation and water ripples, of a final product. The slicing refers to dividing the initial three-dimensional design model into a plurality of slices. The gum line identifying is to identify a gum line of the initial three-dimensional design model, and is mostly used for cutting membranes in invisible orthodontic applications. The marking is configured to add identification information on the initial three-dimensional design model. The punching is configured to add a hole to the initial three-dimensional design model. The jig adding is configured to add a jig to the initial three-dimensional design model, and the jig is configured to be fixed on a cutting device, so as to trim and cut a female die film obtained by hot-pressing film molding. A shape, size and position of the jig are determined according to a retention device of the cutting device.
S300: performing data preprocessing on the initial three-dimensional design model according to the preset processing flow to obtain a preprocessed three-dimensional design model.

In an embodiment, different dental applications have corresponding dental application types, and their corresponding preset processing flows are all different. For example, in the orthodontic application (specifically orthodontic model application), a preset processing flow is straightening-gum line identifying-hollowing out-jig adding-typesetting-slicing. In the implanting application, a preset processing flow is: straightening-hollowing out-typesetting-support adding-slicing. Therefore, depending on different applications, the method may schedule corresponding dental application types and preset processing flows for data processing. It is understood that automatic preprocessing corresponding to the dental applications of the above method belongs to the scope of protection of the disclosure.

In some embodiments, the method for preprocessing three-dimensional printing data is applied to dental implantation. This is, the corresponding dental application type is dental implantation, and a preset processing flow is described in detail as follows: automatically repairing an input dental design model to guarantee that the model has no broken surface; identifying features of the repaired model according to different applications; automatically straightening the model according to the identified model features; then automatically hollowing out the automatically straightened model; and automatically typesetting the hollowed-out model, automatically adding a support to the typeset model, and then automatically slicing the model. The entire process is performed automatically according to a process unique to the dental application.

When the initial three-dimensional design model is processed through the method for preprocessing three-dimensional printing data, automatic processing is performed according to the preset processing flow corresponding to the three-dimensional application type, flows of different three-dimensional applications are solved according to different processing modes, and preset processing flows may be added or deleted according to different requirements. For example, in the dental field, preset processing flows include automatic repairing, automatic straightening, automatic hollowing out, automatic typesetting, automatic support adding, gum line identifying, etc. Therefore, an integrated and automated generation processing flow for different applications provided in the method provides an intelligent system combining a 3D printing technology and an artificial intelligence algorithm, which may greatly improve the three-dimensional model processing and operation efficiency, reduce a manual processing time, and provide better user experience and product advantages. Thus, the method may implement an automatic processing flow of 3D printing data preprocessing, shorten the data processing time and production and processing time of a model, and achieve the technical effects of reducing the labor costs and improving the user experience.

Further, as shown in FIG. 2, the method for preprocessing three-dimensional printing data further includes:
S400: generating the three-dimensional printing data according to the preprocessed three-dimensional design model.

Alternatively, the three-dimensional application type corresponding to the initial three-dimensional design model is intelligently identified by identifying contour features of the model. Furthermore, the three-dimensional application type may also be selected or defined by the user. When the method is applied to the dental field, the dental application type corresponding to the dental design model is obtained by identifying the contour features of the model.

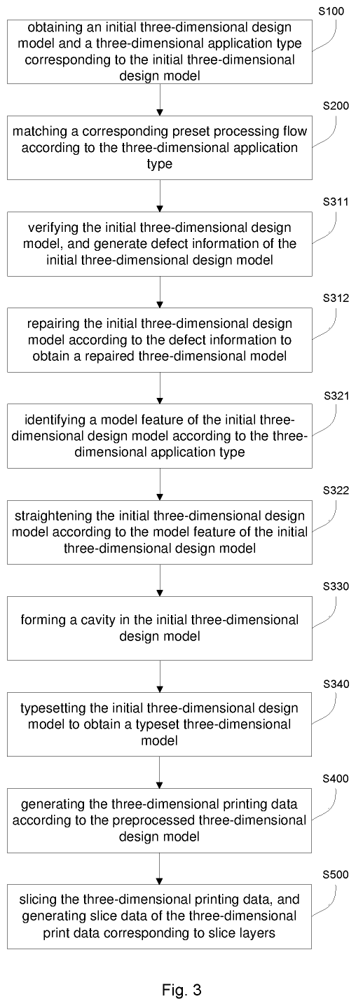

With reference to FIG. 3, FIG. 3 is a schematic flowchart of another method for preprocessing three-dimensional printing data provided in an embodiment of the disclosure.

In an embodiment, steps (specifically repairing steps) of performing data preprocessing on the initial three-dimensional design model according to the preset processing flow to obtain a preprocessed initial three-dimensional design model in S300 include:
S311: verifying the initial three-dimensional design model, and generate defect information of the initial three-dimensional design model; and
S312: repairing the initial three-dimensional design model according to the defect information to obtain a repaired three-dimensional model.

In an embodiment, the initial three-dimensional design model is verified and subject to defect repairing, such that the initial three-dimensional design model can be subject to next operation.

The obtained input three-dimensional design model is a digitized three-dimensional body composed of a series of polygon patches. An arbitrarily oriented dental model with a bottom surface is obtained, and the dental model is a digitized three-dimensional body composed of a series of polygon patches. In a particular instance, the polygon patch is a triangular patch.

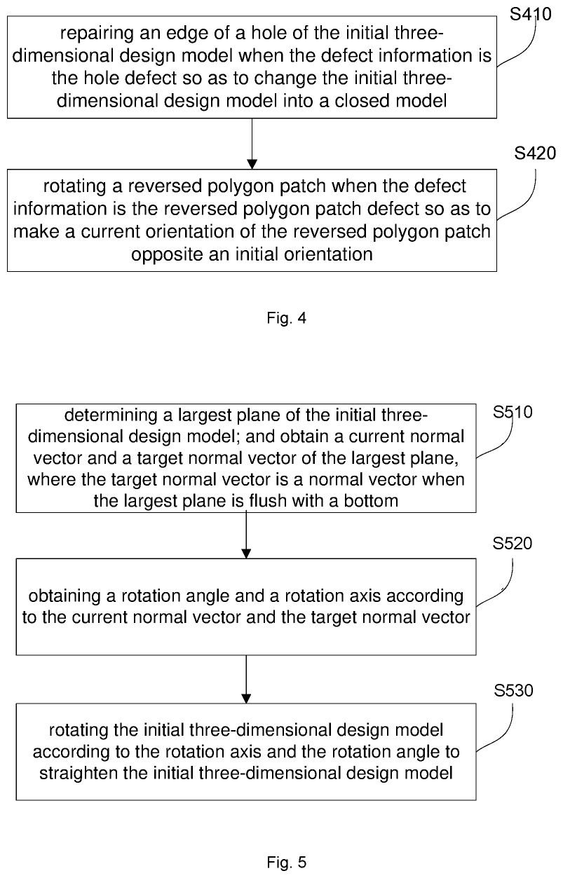

In a particular example, as shown in FIG. 4, the defect information includes a hole defect and a reversed polygon patch defect. The step of obtaining a repaired three-dimensional model includes:
S410, repairing an edge of a hole of the initial three-dimensional design model when the defect information is the hole defect so as to change the initial three-dimensional design model into a closed model; and
S420, rotating a reversed polygon patch when the defect information is the reversed polygon patch defect so as to make a current orientation of the reversed polygon patch opposite an initial orientation.

Specifically, under the condition that defects such as holes and reversed polygon patches are detected, different repairing methods are used for different defects. Under the condition that there is a hole, an edge of the hole of the model is automatically repaired, such that the model becomes a closed area. Under the condition that there is a reversed polygon patch, a normal vector of the reversed polygon patch is reversed. Finally, after automatic repairing, the model can be used for next operation.

In a particular example, the step of verifying the initial three-dimensional design model includes:
determining that the initial three-dimensional design model is defect-free under the condition that the initial three-dimensional design model is a closed model and a normal vector direction of a polygon patch of the initial three-dimensional design model is away from the initial three-dimensional design model.

It should be noted that the normal vector direction of the polygon patch is a direction away from the initial three-dimensional design model, that is, the normal vector of the polygon patch will not coincide with the initial three-dimensional design model.

In some embodiments, a process of verifying the initial three-dimensional design model is verifying all polygon patches of the initial three-dimensional design model (the 3D model is composed of polygon patches). Under the condition that all models form a closed area, and the normal vectors of all polygon patches face outwards, then the model is considered to have no defect and can be directly used for model preliminary processing. In an embodiment, steps (specifically straightening steps) of performing data preprocessing on the three-dimensional design model according to the preset processing flow to obtain a preprocessed three-dimensional design model in S300 include:
S321: identifying a model feature of the initial three-dimensional design model according to the three-dimensional application type; and
S322: straightening the initial three-dimensional design model according to the model feature of the initial three-dimensional design model.

For example, the three-dimensional design model is classified according to the model features, such that the three-dimensional design model is straightened and matched with a corresponding preset processing flow.

In some embodiments, model features of the initial three-dimensional design model are identified for different application types. Since dental model types of the dental application are known, and a straightening requirement of model printing is also known, features are identified according to the straightening of different applications in this method. The purpose of identifying the features is to find a straightening angle of the model. Since different dental models have different application types, their features are inconsistent. Moreover, different dental model types are classified through feature extraction (classification is important for subsequent processing, and different model types require different processing flows).

In a particular example, as shown in FIG. 5, the model features include a largest plane. The step of straightening the initial three-dimensional design model includes:
S510, determining a largest plane of the initial three-dimensional design model; and obtain a current normal vector and a target normal vector of the largest plane, where the target normal vector is a normal vector when the largest plane is flush with a bottom; It should be noted that, ‘the largest plane is flush with a bottom’ refers to that the maximum plane is flush with the bottom surface, or the maximum plane is used as the bottom surface.
S520, obtaining a rotation angle and a rotation axis according to the current normal vector and the target normal vector; and
S530, rotating the initial three-dimensional design model according to the rotation axis and the rotation angle to straighten the initial three-dimensional design model.

Specifically, searching for a largest plane as the feature is taken as an embodiment in the method, and searching for other model features is similar. In an embodiment, after a feature plane (model feature) required for the initial three-dimensional design model is found, a corresponding normal vector is obtained. A rotation angle and a rotation axis required for straightening is solved according to vector values before and after rotation through a cross product operation method. The cross product operation method is a binary operation of vectors in a vector space, and an operation result is a vector instead of a scalar. According to the rotation angle and rotation axis, any model is rotated to a desired spatial position, and then straightened.

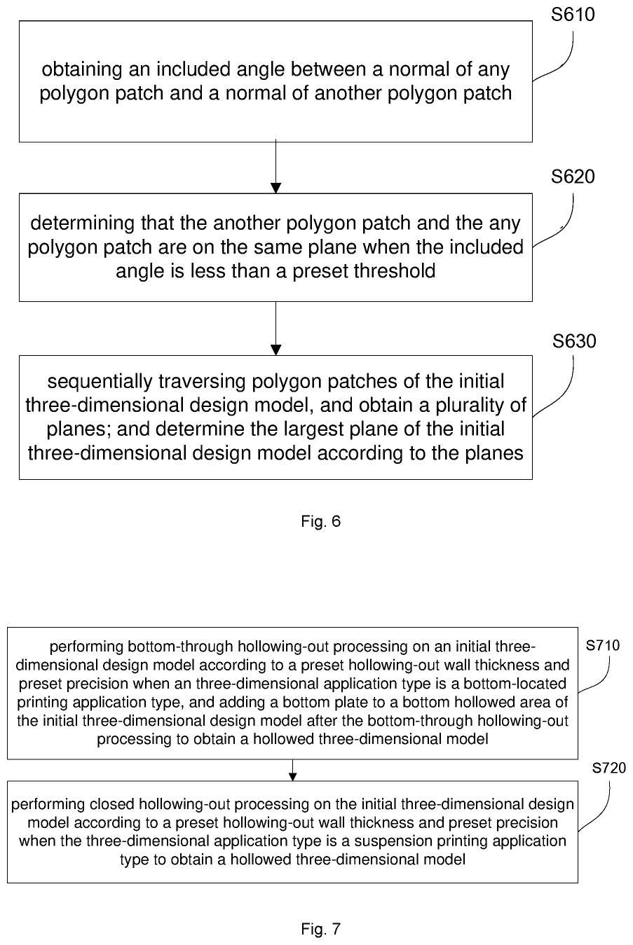

In a specific example, as shown in FIG. 6, the step of determining the largest plane in the initial three-dimensional design model includes:
S610, obtaining an included angle between a normal of any polygon patch and a normal of another polygon patch;
S620, determining that the another polygon patch and the any polygon patch are on the same plane when the included angle is less than a preset threshold; and
S630, sequentially traversing polygon patches of the initial three-dimensional design model, and obtain a plurality of planes; and determine the largest plane of the initial three-dimensional design model according to the planes.

Specifically, according to largest planes of different dental models, a method for detecting a largest plane of teeth includes: setting a certain polygon patch, superimposing the set polygon patch and a 3D dental model composed of polygon patches, setting an error threshold (that is, the preset threshold) e, and when e is greater than a certain value, determining that the set polygon patch is not flush with the patch on the 3D dental model; and otherwise, determining that the set polygon patch and the 3D dental model are in the same plane. When located in the same plane, the set polygon patch and a certain patch of the dental model are superimposed together, and the next polygon patch is searched for and an error threshold is determined. The above steps are repeated until a largest plane of the dental model is found.

In an embodiment, steps (specifically hollowing-out steps) of performing data preprocessing on the initial three-dimensional design model according to the preset processing flow to obtain a preprocessed three-dimensional design model in S300 include:
S330: forming a cavity in the initial three-dimensional design model.

Specifically, the initial three-dimensional design model is formed a cavity to obtain a hollowed three-dimensional model. The solid model is changed into a shell model through the above method, which may effectively save printing material.

A photosensitive resin material is one of the materials for 3D printing. The photosensitive resin material is shrunk in a curing process, the larger a physical volume of the printed part is, the more obvious a shrinkage phenomenon is, such that the printed part is formed a cavity to obtain an internally hollowed printed part, then a shrinkage degree of the printed part is less, a size change of the printed part is less, and printing material is saved.

In some implementation scenes, the method for preprocessing three-dimensional printing data is applied to the dental field. Hollow processing may also be called hollowing-out processing. For different applications in the dental field, the hollowing-out operation may not be used, and the subsequent operation of adding a bottom plate will be different. Specifically, the step of forming a cavity in the initial three-dimensional design model includes:

hollowing out the initial three-dimensional design model according to a preset hollowing-out wall thickness, a preset precision value, and the three-dimensional application type corresponding to the initial three-dimensional design model to obtain a hollowed three-dimensional model.

Further, as shown in FIG. 7, the step of hollowing out the initial three-dimensional design model includes:
S710, performing bottom-through hollowing-out processing on an initial three-dimensional design model according to a preset hollowing-out wall thickness and preset precision when an three-dimensional application type is a bottom-located printing application type, and adding a bottom plate to a bottom hollowed area of the initial three-dimensional design model after the bottom-through hollowing-out processing to obtain a hollowed three-dimensional model, it should be noted that ‘bottom-located’ means that, in the preprocessing process, the maximum plane of the initial three-dimensional design model is used as the bottom surface, and the bottom of the solid printing piece subsequently obtained by 3D printing is flush with or attached to the molding surface of the molding platform; and
S720: performing closed hollowing-out processing on the initial three-dimensional design model according to a preset hollowing-out wall thickness and preset precision when the three-dimensional application type is a suspension printing application type to obtain a hollowed three-dimensional model.

The bottom-through hollowing-out processing is to hollow out the entire initial three-dimensional design model from the bottom of the initial three-dimensional design model, and the bottom of the three-dimensional design model is not closed after processing. The closed hollowing-out processing is to hollow out the interior of the three-dimensional design model, and the entire three-dimensional design model is still a closed model after processing.

Specifically, for the application of an orthodontic model, after placing the model to a specified position, according to the classification of the three-dimensional design model in S321, the corresponding dental model is hollowed out (similar to unshelling operation). The hollowing out of the dental model is to hollow out the interior of the model whose bottom surface is solid. A hollowing-out algorithm is based on a set hollowing-out wall thickness and a precision value (a preset value), shrinking is performed on the same model, then overlapping is performed, and the bottom is opened to form a hollowed-out model. In short, a solid model becomes a shell model. Such operation may save printing material. Since the model is hollowed out, a bottom plate needs to be added in the hollowed-out area. As for a bottom plate of the dental model, since the printed dental model is hollowed out, in order to prevent deformation and contraction of the dental model, the bottom plate needs to be provided for the printed dental model, to overcome the deformation. Since factors of leakage, material saving, process treatment, etc. need to be considered, it is necessary to add a bottom plate with meshes to the printed dental model. The meshes are circular holes, honeycomb holes, square holes, etc.

Specifically, on the premise of not influencing the use of the product, the bottom plate is exposed to a surface of the model. Certainly, in order to guarantee the attraction of the final printed product and save material, the bottom plate is generally not exposed to the surface of the model. Since an orthodontic dental mold typically uses bottom-located printing, that is, the bottom of the dental mold is directly attached to the prototyping surface of the molding platform (also called printing platform) and directly prototyped on the prototyping surface. Therefore, the prototyping surface and the bottom plate will block discharge of material out of the hollowed-out portion, such that the bottom plate needs to have meshes, and the molding platform will also be made into a flat plate with through holes. In this way, the material in the hollowed-out portion is smoothly discharged through the meshes of the bottom plate and the through holes of the molding platform.

For a hole-free platform, the mesh design of the bottom plate is useless. In this case, a side surface of the dental mold needs to be provided with holes. Therefore, it is preferable that the type of a molding platform of a printer also needs to be identified before preliminary processing.

In an embodiment, for a suspended three-dimensional design model, some models are not suitable for bottom-located printing, such as implant guides, crowns, trays, baseplates, removable denture brackets, etc. These applications typically have a plurality of support structures, and bottom ends of the support structures are fixedly connected to the prototyping surface. Removing models (shoveling parts) is troublesome since the support structures are numerous and small. Moreover, since the prototyping surface is provided with through holes, the bottom ends of some support structures may correspond to the through holes and be suspended, bringing the risk of falling. In summary, in order to facilitate removing models and avoid falling, a bottom plate will be provided between the bottom ends of the support structures and the prototyping surface, that is, the first layer of printing is the bottom plate. During removing models, the bottom plate is directly separated from the prototyping surface without removing the support structures one by one.

In an embodiment, the step of performing data preprocessing on the initial three-dimensional design model according to the preset processing flow to obtain a preprocessed three-dimensional design model in S300 includes:
S340: typesetting the initial three-dimensional design model to obtain a typeset three-dimensional model.

In an embodiment, the typeset three-dimensional model is arranged on the design layout corresponding the printing platform according to an original straightening angle of the model before printing. The printing platform sizes of different printers are inconsistent, and the method may arrange the printed models as full as possible according to a specific printing platform size.

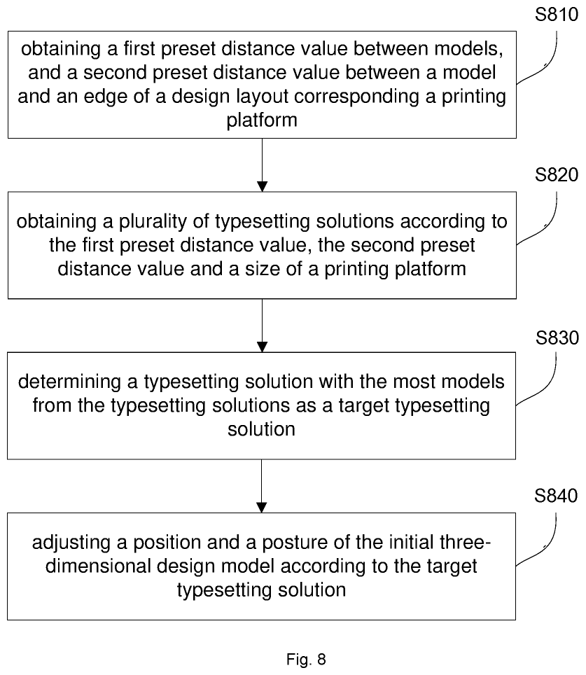

In a specific example, as shown in FIG. 8, typesetting includes:
S810, obtaining a first preset distance value between models, and a second preset distance value between a model and an edge of a design layout corresponding a printing platform;
S820, obtaining a plurality of typesetting solutions according to the first preset distance value, the second preset distance value and a size of a printing platform;
S830, determining a typesetting solution with the most models from the typesetting solutions as a target typesetting solution; and
S840, adjusting a position and a posture of the initial three-dimensional design model according to the target typesetting solution.

Specifically, the three-dimensional design model and the corresponding hollowed three-dimensional model are obtained (according to classification identification, some models need to form a cavity or not), and typesetting is performed with maximum efficiency. The typesetting is to arrange the models on the printing platform according to the original straightening angle before printing, the printing platform sizes of different printers are inconsistent, and the method may arrange the printed models as full as possible according to the specific printing platform size. The typesetting method is enumeration, that is, a model is adjusted at an angle several times, and the models are continuously adjusted and placed under the parameter limit of distance A1 between the models and distance A2 between the models and the edge of the design layout corresponding the printing platform, such that the models are placed with maximum efficiency, that is, the maximum number of three-dimensional design models are placed under the condition that the parameter limit is satisfied. The values of A1 and A2 need to be preset according to user requirements.

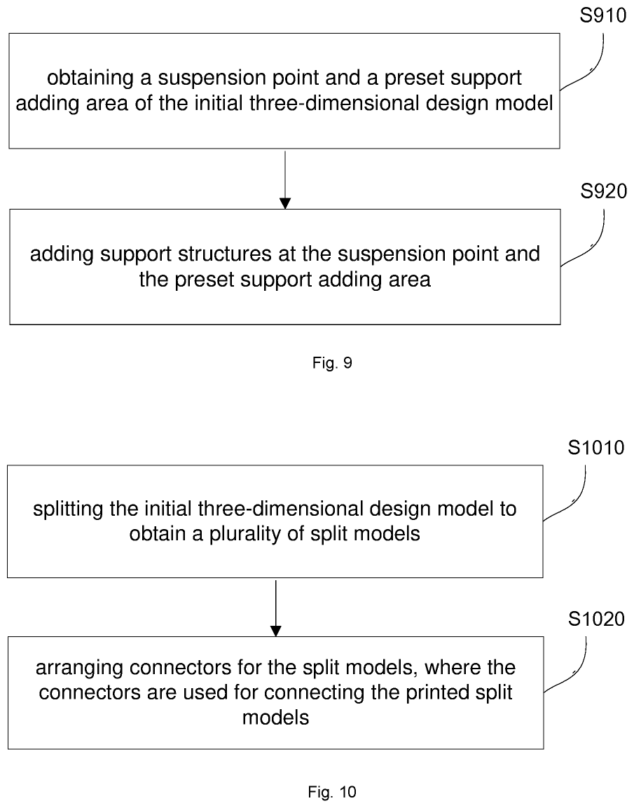

In a specific example, as shown in FIG. 9, support adding includes:
S910, obtaining a suspension point and a preset support adding area of the initial three-dimensional design model; and
S920, adding support structures at the suspension point and the preset support adding area.

In some embodiments, the typeset three-dimensional model obtained in S340 is obtained, and then a support is added to the typeset three-dimensional model (according to classification identification, some models need support or not). Support adding is to add columns to the suspended model (which is set in the typesetting stage) to support the model for printing, or to add a support to the hollowed three-dimensional model, to guarantee that the internally hollowed-out model does not fall off during printing. Support adding follows the principles: first, for a model that needs to be supported, a lowest point (suspension point) is found, that is, the lowest point has a support; second, according to special requirements of the dental application, areas that do not need to be supported are automatically avoided, for example, the appearance of the model needs no support, and a designed hole in the model needs no support (the hole is used for wearing or working areas); and third, since the support needs to be removed finally, in the support strategy of the method is settable on a support contact point area, and the support is easily disassembled under the condition that the model cannot fall off during printing.

In an embodiment, after the step of generating three-dimensional printing data according to the preprocessed three-dimensional design model in S400, the method further includes:
S500: slicing the three-dimensional printing data, and generating slice data of the three-dimensional print data corresponding to slice layers.

In an embodiment, slicing the three-dimensional printing data may convert the three-dimensional printing data into identifiable files. Slicing is to cut a three-dimensional object into layers, that is, to generate a printing picture of each layer, so as to form a solid object in a way that layers are continuously superimposed during printing.

In some embodiments, after the supported model is obtained, the model needs to be converted into a file identifiable by a printer, that is, the three-dimensional model needs to be sliced. Slicing is to cut the three-dimensional object into layers, that is, to generate a printing picture of each layer, so as to form a solid object in a way that layers are continuously superimposed during printing.

In a particular instance, slicing includes: dividing the initial three-dimensional design model into a plurality of slice images according to a preset slice parameter. The preset slice parameter includes a preset slice layer thickness and a preset image resolution, and the preset image resolution is obtained according to a size of a molding platform. Further, the step further includes: performing an edge processing on the slice image.

Specifically, the automatic slicing in the method is based on preset slicing parameters. The first parameter is a slice thickness, that is, the accuracy of the slice. The higher the accuracy is, the closer a printed model is to the three-dimensional design model (the defect is that the time is longer), and on the contrary, the surface of the model is rough. The second parameter is a corresponding picture resolution automatically generated according to the size of the molding platform. Then, the edge of the image of each layer is post-processed to make the printed surface smooth. Through the above steps, the data preliminary processing flow of the dental application is completed.

The disclosure further provides a three-dimensional printing method, including: obtaining slice data through the method for preprocessing three-dimensional printing data; and based on the slice data, making a three-dimensional printing apparatus print slice layers one by one, to obtain a cured layer corresponding to each slice layer, and obtaining a three-dimensional solid object corresponding to a printed part after accumulating the cured layers one by one.

In some embodiments, the three-dimensional printing method further includes: determining a process package according to the three-dimensional application type, the printing layer thickness and the type of resin material. The three-dimensional printing apparatus may print according to the slice data by using the parameters of the process package. It should be noted that the process package may also be determined according to the three-dimensional application type, the printing layer thickness, the type of resin material, and parameters selected by the user.

In an embodiment, the 3D printing modes include various 3D printing methods in the industry. Certainly, different printing modes may influence the preliminary processing operation, for example, powder 3D printing, inkjet photocuring 3D printing requires no support adding operation. The examples are preferably stereo lithography appearance (SLA), digital light processing (DLP), liquid-crystal display (LCD), and liquid crystal on silicon (LCOS) photocuring 3D printing.

In an embodiment, as shown in FIG. 10, editing includes:
S1010, splitting the initial three-dimensional design model to obtain a plurality of split models; and
S1020, arranging connectors for the split models, where the connectors are used for connecting the printed split models.

The three-dimensional design model is split by any means in the art, a split position may also be determined according to actual requirements, and the three-dimensional design model is split into any number of split models. Connectors are arranged for the split models. The connectors are set at any positions. For example, the connectors are set on a surface formed by splitting the model, or on other surfaces.

Specifically, the connector is a mortise and tenon structure, a pin structure or other fixing structure, and is configured to connect the split models after printing. For example, a joint part of a hand is printed by the editing means as above, such that an upper arm and a forearm of the hand are movably connected.

In some implementation scenes, the method may also include gum line identifying and automatic jig adding in the orthodontic application in the dental field. In the orthodontic application, orthodontic bonding guides, orthodontic models for membrane pressing, aligner models for direct printing, etc. is designed. For the application of an orthodontic model, the orthodontic model is finally used for membrane pressing, a shell membrane is pressed, then is cut by a cutting apparatus according to a cutting track, and is further polished, and then a trayless aligner is obtained. The cutting track is designed according to a gum line. During preliminary processing, a gum line of teeth needs to be identified. Specifically, a plurality of gum line feature points are captured, and then are fitted to obtain a target curve. Final data output to the user includes the slices for printing and the target curve.

In an embodiment, the target curve is smoothed and offset (towards a tooth end of the gum line), and a resulting target curve is used as a cutting track curve. During cutting, the orthodontic dental solid model will bear the shell membrane, and in order to make the dental model smoothly cooperate with a fixture on a cutting machine, a jig block needs to be added to the digital three-dimensional model of the orthodontic model, and the shape of the jig block is designed according to the fixture.

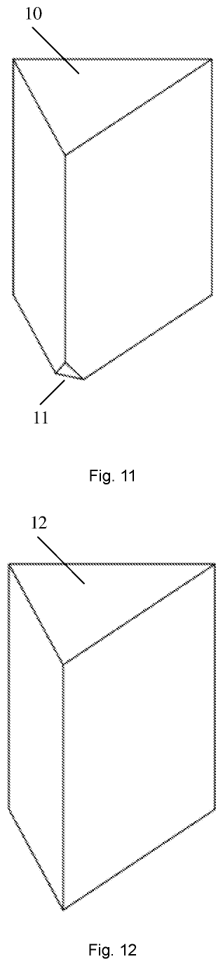

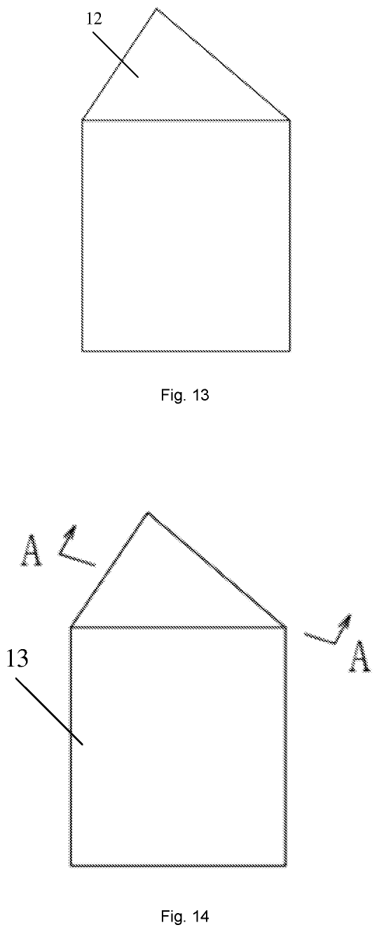

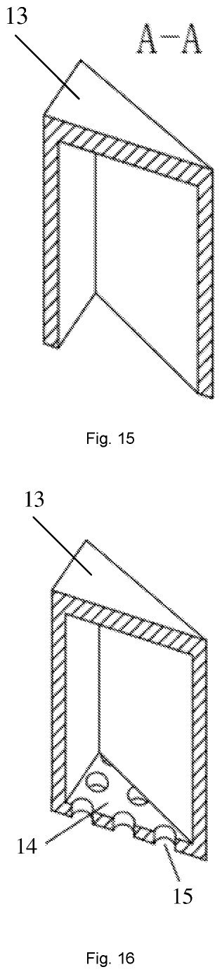

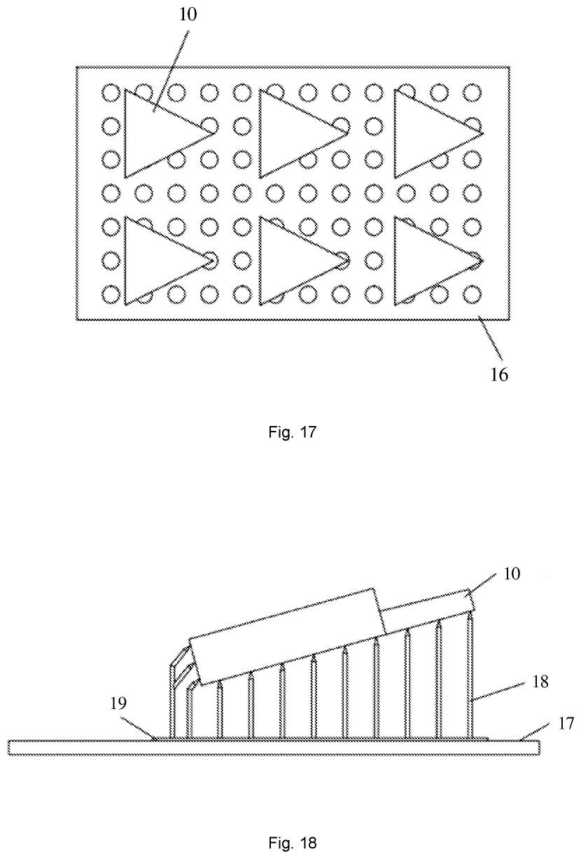

With reference to FIGS. 11-18, FIG. 11 is a schematic structural diagram of a defective three-dimensional design model according to an embodiment of the disclosure; FIG. 12 is a schematic structural diagram of a repaired three-dimensional model according to an embodiment of the disclosure; FIG. 13 is a schematic structural diagram of a straightened repaired three-dimensional model according to an embodiment of the disclosure; FIG. 14 is a schematic structural diagram of a hollowed three-dimensional model according to an embodiment of the disclosure; FIG. 15 is a sectional view of a hollowed three-dimensional model according to an embodiment of the disclosure; FIG. 16 is a schematic structural diagram of a hollowed three-dimensional model, a bottom plate and meshes according to an embodiment of the disclosure; FIG. 17 is a schematic structural diagram of a typeset three-dimensional model according to an embodiment of the disclosure; and FIG. 18 is a structural side view of a typeset three-dimensional model according to an embodiment of the disclosure. Sections A-A of FIGS. 14 and 15 correspond to each other. Numerals are as follows: three-dimensional design model 10, defect 11, repaired three-dimensional model 12, hollowed three-dimensional model 13, bottom plate 14, mesh 15, typeset three-dimensional model 16, prototyping surface 17, support structure 18, prototyping bottom plate 19.

In an embodiment, models and mechanisms shown in FIGS. 11-18 correspond to the method examples shown in FIGS. 1 and 2, which will not be repeated herein to avoid repetition.

In an embodiment, the typeset three-dimensional model 16 includes a prototyping surface 17, a support structure 18, and a prototyping bottom plate 19, and the three-dimensional design model 10 is connected to the support structure 18 on the upper side of the support structure 18.

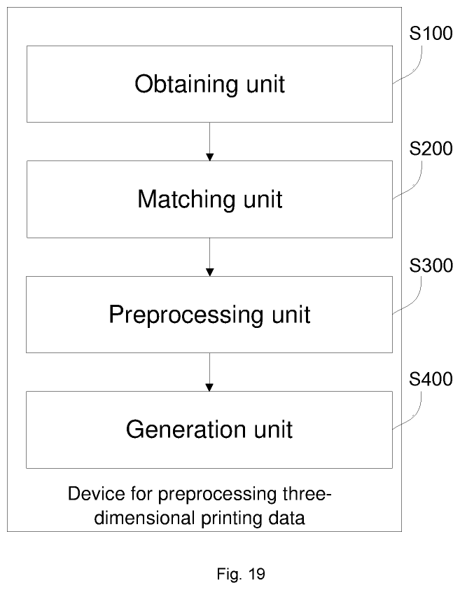

With reference to FIG. 19, FIG. 19 is a structural block diagram of a device for preprocessing three-dimensional printing data according to an embodiment of the disclosure. The device for preprocessing three-dimensional printing data includes:
an obtaining unit 100 configured to obtain an initial three-dimensional design model and a three-dimensional application type corresponding to the initial three-dimensional design model;
a matching unit 200 configured to match a corresponding preset processing flow according to the three-dimensional application type; and
a preprocessing unit 300 configured to perform data preprocessing on the initial three-dimensional design model according to the preset processing flow to obtain a preprocessed three-dimensional design model.

Further, the device for preprocessing three-dimensional printing data further includes:
a generation unit 400 configured to generate the three-dimensional printing data according to the preprocessed three-dimensional design model.

In an embodiment, the preprocessing unit 300 includes:
a verification unit configured to verify the initial three-dimensional design model and generate defect information of the three-dimensional design model and further configured to determine that the initial three-dimensional design model is defect-free under the condition that the initial three-dimensional design model is a closed model and a normal vector direction of a polygon patch of the initial three-dimensional design model is away from the initial three-dimensional design model; and
a repairing unit configured to repair the three-dimensional design model according to the defect information to obtain a repaired three-dimensional model, and further configured to repair an edge of a hole of an initial three-dimensional design model when defect information is a hole defect so as to change the initial three-dimensional design model into a closed model; and rotate a reversed-polygon patch when the defect information is a reversed-polygon patch defect so as to make a current orientation of the reversed-polygon patch opposite an initial orientation.

In an embodiment, the preprocessing unit 300 further includes:
a feature identification unit configured to identify a model feature of the three-dimensional design model according to the three-dimensional application type; and
a straightening unit configured to straighten the three-dimensional design model according to the model feature of the three-dimensional design model, and further configured to determine a largest plane of an initial three-dimensional design model; obtain a current normal vector and a target normal vector of the largest plane, where the target normal vector is a normal vector when the largest plane is flush with a bottom; obtain a rotation angle and a rotation axis according to the current normal vector and the target normal vector; and rotate the initial three-dimensional design model according to the rotation axis and the rotation angle to straighten the initial three-dimensional design model. The straightening unit is further configured to obtain an included angle between a normal of any polygon patch and a normal of another polygon patch; determine that the another polygon patch and the any polygon patch are on the same plane when the included angle is less than a preset threshold; sequentially traverse polygon patches of an initial three-dimensional design model to obtain a plurality of planes; and determine a largest plane of the initial three-dimensional design model according to the planes.

In an embodiment, the preprocessing unit 300 further includes:
a forming cavity processing unit configured to form a cavity in the initial three-dimensional design model to obtain a hollowed three-dimensional model. The hollow processing unit is further configured to hollow out the three-dimensional design model according to a preset hollowing-out wall thickness, a preset precision value, and the three-dimensional application type corresponding to the initial three-dimensional design model to obtain a hollowed three-dimensional model. The forming cavity processing unit is further configured to perform bottom-through hollowing-out processing on the initial three-dimensional design model according to a preset hollowing-out wall thickness and preset precision when the three-dimensional application type is a bottom-located printing application type, add a bottom plate to a bottom hollowed area of the initial three-dimensional design model after the bottom-through hollowing-out processing to obtain a hollowed three-dimensional model. The forming cavity processing unit is further configured to perform a closed hollowing-out processing on the initial three-dimensional design model according to a preset hollowing-out wall thickness and preset precision when the three-dimensional application type is a suspension printing application type to obtain a hollowed three-dimensional model.

In an embodiment, the preprocessing unit 300 further includes:
a typesetting unit configured to typeset the initial three-dimensional design model to obtain a typeset three-dimensional model. The typesetting unit is further configured to obtain a first preset distance value between models, and a second preset distance value between a model and an edge of a design layout corresponding a printing platform; obtain a plurality of typesetting solutions according to the first preset distance value, the second preset distance value and a size of a printing platform; determine a typesetting solution with the most models from the typesetting solutions as a target typesetting solution; and adjust a position and a posture of the initial three-dimensional design model according to the target typesetting solution.

In an embodiment, the preprocessing unit 300 further includes:
an editing unit configured to split the initial three-dimensional design model to obtain a plurality of split models, and arrange connectors for the split models, where the connectors are used for connecting the printed split models.

In an embodiment, the preprocessing unit 300 further includes:
a support adding unit configured to add a support to the typeset three-dimensional model, and further configured to obtain a suspension point and a preset support adding area of the initial three-dimensional design model; and additionally arrange support structures at the suspension point and the preset support adding area; and
a gum line identification unit configured to identify a gum line of teeth and perform fitting to obtain a target curve.

In an embodiment, the preprocessing unit 300 further includes:
a slicing unit configured to slice the three-dimensional printing data and generate slice data of the three-dimensional print data corresponding to slice layers, and further configured to divide the initial three-dimensional design model into a plurality of slice images according to a preset slice parameter, and perform an edge processing on the slice image; and
a jig adding unit configured to add a jig block to the three-dimensional design model.

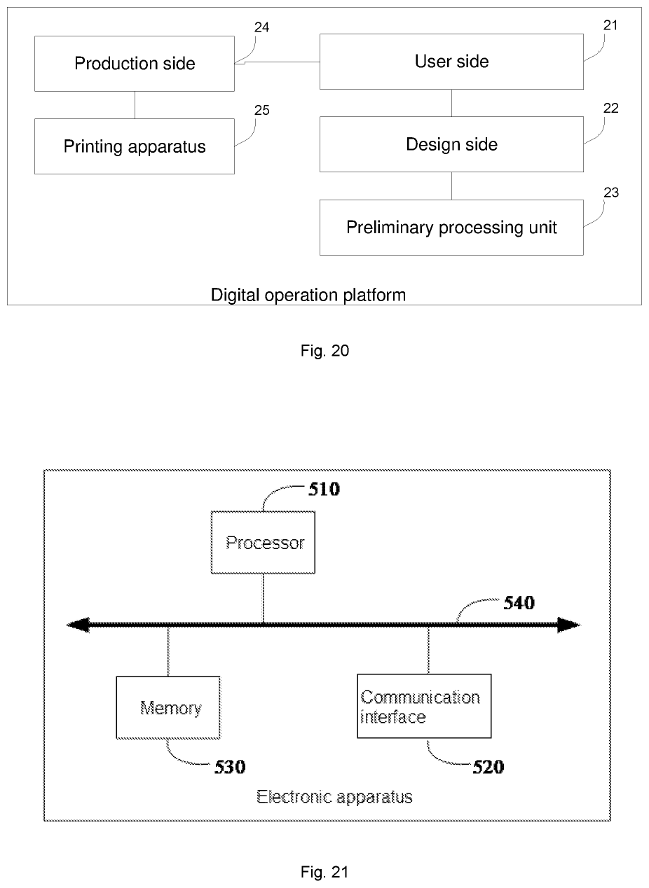

With reference to FIG. 20, FIG. 20 is a structural block diagram of a digital operation platform according to an embodiment of the disclosure. The digital operation platform includes a user side 21, a design side 22 and a preliminary processing unit 23.

The user side 21 is configured to collect three-dimensional scanning data and order information of a target.

The design side 22 is configured to receive the three-dimensional scanning data and the order information, and generate an initial three-dimensional design model according to the three-dimensional scanning data.

The preliminary processing unit 23 is configured to generate three-dimensional printing data according to the method for preprocessing three-dimensional printing data according to any one of embodiments.

The digital operation platform further includes a production side 24, where the production side 24 is configured to receive the three-dimensional printing data, and the production side 24 is connected to a printing apparatus 25 and sends the three-dimensional printing data to the printing apparatus 25.

A use process of the digital operation platform is as follows.

First, the user side 21 uploads scanning data to the digital operation platform. For a dental application, the scan data includes, but is not limited to, oral scanning data (including computed tomography (CT), cone beam computed tomography (CBCT), and oral scan), impression scanning data, plaster cast scanning data, etc. For an orthopedic application, uploaded scanning data includes, but is not limited to, CT images, 3D scan data of a torso of a patient, etc. For a consumer domain, designing a customized helmet requires user head scanning data, designing a customized shoe midsoles requires user sole scanning data (3D sole scanning data or sole impression scanning data). For an earphone application, uploaded scanning data includes, but is not limited to, three-dimensional scanning data of ears. CT refers to computed tomography, CBCT refers to cone beam CT, and oral scan refers to an oral scanner.

Then, the user side 21 creates an order on the digital operation platform. Order information includes design types. For example, the design types include an implant guide, an orthodontic model, a dental bridge, a removable prosthesis, an orthopedic brace, earphone, etc. According to different design types, the order information further includes design requirement information. The design requirement information is special design requirements of a user, information related to tooth positions, etc., and the order information include diagnosis and treatment information of a patient.

Then, after the order is created, the digital operation platform sends the three-dimensional scanning data and the order to a designer, and the designer make a design according to the order information and the three-dimensional scanning data, and outputs a design solution. The design solution at least includes a three-dimensional design model, and the design solution may further include a product use description. A product is a three-dimensional solid model obtained by printing and prototyping according to the three-dimensional model data.

Then the preliminary processing unit preprocesses the three-dimensional design model, and generates three-dimensional printing data.

Finally, the three-dimensional printing data is sent to the production side 24, the production side 24 mainly performs production management and is connected to at least one printing apparatus. Further, the production side 24 is also connected to at least one post-processing apparatus, and the post-processing apparatus includes a post-curing apparatus and a resin cleaning apparatus. The production side 24 will intelligently schedule one or more pieces of three-dimensional printing data and deliver the three-dimensional printing data to appropriate printing apparatuses.

Further, the digital operation platform includes a user side, a design side and a preliminary processing unit.

The user side is configured to obtain three-dimensional scanning data of a target;

The design side is configured to receive the three-dimensional scanning data and generate an initial three-dimensional design model according to the three-dimensional scanning data; and

The preliminary processing unit is configured to generate a preprocessed three-dimensional design model according to the method for preprocessing three-dimensional printing data according to any one of above items.

The digital operation platform further includes a production side, where the production side is configured to receive the preprocessed three-dimensional design model, and the production side is connected to a printing apparatus and sends the preprocessed three-dimensional design model to the printing apparatus.

The disclosure further provides an electronic apparatus. With reference to FIG. 21, FIG. 21 is a structural block diagram of an electronic apparatus provided in an embodiment of the disclosure. The electronic apparatus includes a processor 510, a communication interface 520, a memory 530, and at least one communication bus 540. The communication bus 540 is configured to achieve direct connection communication between these assemblies. The communication interface 520 of the electronic apparatus in the example of the disclosure is configured to implement signaling or data communication with other node apparatuses. The processor 510 is an integrated circuit chip having a signal processing capability.

The processor 510 is a general-purpose processor, including a central processing unit (CPU), a network processor (NP), etc., and may also be a digital signal processor (DSP), an application specific integrated circuit (ASIC), a field programmable gate array (FPGA), other programmable logic device, a discrete gate, a transistor logic device, or a discrete hardware assembly. The methods, steps and logical block diagrams disclosed in the examples of the disclosure is implemented or executed by the processor 510. The general-purpose processor is a microprocessor or the processor 510 may also be any conventional processor, etc.

The memory 530 is, but is not limited to, a random access memory (RAM), a read only memory (ROM), a programmable read-only memory (PROM), an erasable programmable read-only memory (EPROM), an electric erasable programmable read-only memory (EEPROM), etc. The memory 530 stores a computer-readable instruction. When the computer-readable instruction is executed by the processor 510, the electronic apparatus may execute the above steps in the method examples of FIGS. 1-2.

Alternatively, the electronic apparatus further includes a memory controller and an input and output unit.

The memory 530, the memory controller, the processor 510, a peripheral interface, and the input and output unit are electrically connected to each other directly or indirectly, so as to achieve data transmission or interaction. For example, these elements are electrically connected to each other via one or more communication buses 540. The processor 510 is configured to execute an executable unit stored in the memory 530, such as a software functional unit or a computer program included in the electronic apparatus.

The input and output unit is configured to allow a user to create a task, and create a selectable start time period or preset execution time for the task, to implement interaction between the user and a server. The input and output unit is, but is not limited to, a mouse, a keyboard, etc.

It is understood that a structure shown in FIG. 21 is illustrative only. The electronic apparatus further includes more or fewer assembly than that shown in FIG. 21, or have a different configuration from that shown in FIG. 21. The assemblies shown in FIG. 21 are implemented in hardware, software, or a combination thereof.

An embodiment of the disclosure further provides a storage medium, storing an instruction. When the instruction runs on a computer, the computer program is executed by a processor such that a method of the method example is implemented, which will not be repeated herein to avoid repetition.

An embodiment of the disclosure further provides a computer program product. The computer program product runs on a computer, the computer executes the method of the method example.

In the examples provided in the disclosure, it should be understood that the disclosed devices and methods may also be implemented in other ways. The device examples described above are merely illustrative. For example, the flowcharts and block diagrams in the accompanying drawings illustrate the architecture, functionality, and operation possibly implemented by the devices, methods, and computer program products according to various examples of the disclosure. In this regard, each block in the flowcharts or block diagrams may represent a unit, a program segment, or a portion of a code, and a unit, a program segment, or a portion of a code includes one or more executable instructions for implementing a specified logical function. It should also be noted that in some alternative implementation modes, a function noted in a block may occur in a different order than noted in the figures. For example, two consecutive blocks may actually be executed substantially in parallel, or in reverse order sometimes, depending on a function involved. It should also be noted that each block in the block diagrams and/or flowcharts, and combinations of blocks in the block diagrams and/or flowcharts, is implemented by special purpose hardware-based systems that perform specified functions or acts, or is implemented by combinations of special purpose hardware and computer instructions.

Moreover, the function units in the examples of the disclosure are integrated into an independent part, or each unit is present separately, or two or more units are integrated into an independent part.

The function is stored in a non-transitory computer-readable storage medium when implemented in the form of a software function unit and sold or used as an independent product. Based on such understanding, the technical solution of the disclosure is embodied in the form of a software product in essence or a part contributing to the prior art or part of the technical solution, and the computer software product is stored in a storage medium and includes a plurality of instructions for making a computer apparatus (which is a personal computer, a server or a network device, etc.) execute all or part of the steps of the methods described in the various examples of the disclosure. The foregoing storage medium includes: a USB flash disk, a mobile hard disk, a read-only memory (ROM), a random access memory (RAM), a magnetic disk, an optical disk and other media capable of storing program codes.

### INDUSTRIAL APPLICABILITY

The solution provided in the example of the disclosure is applied to the technical field of 3D printing. In the example of the disclosure, the method includes: obtaining a three-dimensional design model and a three-dimensional application type corresponding to the three-dimensional design model; matching a corresponding preset processing flow according to the three-dimensional application type; and performing data preprocessing on the three-dimensional design model according to the preset processing flow to obtain a preprocessed three-dimensional design model. The method may achieve the technical effects of reducing labor costs automatically.

What are described above are merely the examples of the disclosure and are not intended to limit the scope of protection of the disclosure, and various changes and modifications is made by those skilled in the art. Any modifications, equivalent substitutions, improvements, etc. within the spirit and principles of the disclosure are intended to fall within the scope of protection of the disclosure. It should be noted that similar numerals and letters denote similar items in the following accompanying drawings, and therefore, once an item is defined in one accompanying drawing, it need not be further defined and explained in the subsequent accompanying drawings.

What are described above are merely being particular embodiments of the disclosure, and are not intended to limit the scope of protection of the disclosure, and any changes or substitutions that may readily occur to those skilled in the art within the scope of technology disclosed in the disclosure should fall within the scope of protection of the disclosure. Therefore, the scope of protection of the disclosure shall be subject to the scope of protection of the claims.

It should be noted that the relation terms, for example, first, second, etc., are used herein merely for distinguishing one entity or operation from another entity or operation but do not necessarily require or imply that there exists any actual relation or sequence between these entities or operations. Moreover, the terms “include”, “comprise”, or their any other variations are intended to cover non-exclusive inclusions, such that a process, a method, an article, or an apparatus including a series of elements not only includes those elements, but also includes other elements that are not explicitly listed, or also includes inherent elements of the process, the method, the article, or the apparatus. In the case of no more limitations, the element limited by the sentence “comprising a . . . ” and “including a . . . ” does not exclude that there exists another same element in the process, method, merchandise or apparatus comprising the element.

It should be noted that the examples in the disclosure and features in the examples are combined without conflicts.

It should be noted that unless otherwise defined, all technical and scientific terms used in the disclosure have the same meanings usually understood by the general technical personnel in the technical field of the disclosure.

In the disclosure, the directional terms such as “upper”, “lower”, “top”, and “bottom” are used generally with respect to directions shown in the drawings, or with respect to vertical, perpendicular, or gravitational directions of components unless otherwise specified. Similarly, for ease of understanding and description, “inner” and “outer” refer to inner and outer relative to contours of the components, but the above directional terms are not intended to limit the disclosure.

Apparently, the examples described are merely some examples rather than all examples of the disclosure. Based on the examples of the disclosure, all other examples obtained by those of ordinary skill in the art without making creative efforts should fall within the scope of protection of the disclosure.

What is claimed is:

1. A method for preprocessing three-dimensional printing data, performed by a computer, the method comprises:
obtaining an initial three-dimensional design model and a three-dimensional application type corresponding to the initial three-dimensional design model;
matching a corresponding preset processing flow according to the three-dimensional application type; and
performing data preprocessing on the initial three-dimensional design model according to the preset processing flow to obtain a preprocessed three-dimensional design model.

2. The method for preprocessing three-dimensional printing data according to claim 1, further comprising:
generating three-dimensional printing data according to the preprocessed three-dimensional design model.

3. The method for preprocessing three-dimensional printing data according to claim 1, wherein the preset processing flow comprises any one or any combination of the following flows: structure detecting, repairing, straightening, editing, hollowing out, typesetting, surface texture processing, support adding, simulating, slicing, gum line identifying, marking, punching and jig adding.

4. The method for preprocessing three-dimensional printing data according to claim 3, wherein the repairing comprises:
verifying the initial three-dimensional design model, and generating defect information of the initial three-dimensional design model; and
repairing the initial three-dimensional design model according to the defect information to obtain a repaired three-dimensional model.

5. The method for preprocessing three-dimensional printing data according to claim 4, wherein the defect information comprises a hole defect and a reversed polygon patch defect, the repairing the initial three-dimensional design model according to the defect information to obtain a repaired three-dimensional model comprises:
repairing an edge of a hole of the initial three-dimensional design model when the defect information is the hole defect so as to change the initial three-dimensional design model into a closed model; and
rotating a reversed polygon patch when the defect information is the reversed polygon patch defect so as to make a current orientation of the reversed polygon patch opposite an initial orientation;
and/or the verifying the initial three-dimensional design model comprises:
determining that the initial three-dimensional design model is defect-free under the condition that the initial three-dimensional design model is a closed model and a normal vector direction of a polygon patch of the initial three-dimensional design model is away from the initial three-dimensional design model.

6. The method for preprocessing three-dimensional printing data according to claim 3, wherein the straightening comprises:
identifying a model feature of the initial three-dimensional design model according to the three-dimensional application type; and
straightening the initial three-dimensional design model according to the model feature of the initial three-dimensional design model.

7. The method for preprocessing three-dimensional printing data according to claim 6, wherein the model feature comprises a largest plane; and the straightening the initial three-dimensional design model comprises:
determining a largest plane of the initial three-dimensional design model; obtaining a current normal vector and a target normal vector of the largest plane, wherein the target normal vector is a normal vector when the largest plane is flush with a bottom;
obtaining a rotation angle and a rotation axis according to the current normal vector and the target normal vector; and
rotating the initial three-dimensional design model according to the rotation axis and the rotation angle to straighten the initial three-dimensional design model.

8. The method for preprocessing three-dimensional printing data according to claim 7, wherein the determining a largest plane of the initial three-dimensional design model comprises:
obtaining an included angle between a normal of any polygon patch and a normal of another polygon patch;
determining that the another polygon patch and the any polygon patch are on the same plane when the included angle is less than a preset threshold;
sequentially traversing polygon patches of the initial three-dimensional design model to obtain a plurality of planes; and determining the largest plane of the initial three-dimensional design model according to the planes.

9. The method for preprocessing three-dimensional printing data according to claim 3, wherein the hollowing out comprises:
forming a cavity in the initial three-dimensional design model.

10. The method for preprocessing three-dimensional printing data according to claim 9, wherein the forming a cavity in the initial three-dimensional design model comprises:
hollowing out the initial three-dimensional design model according to a preset hollowing-out wall thickness, a preset precision value, and the three-dimensional application type corresponding to the initial three-dimensional design model to obtain a hollowed three-dimensional model.

11. The method for preprocessing three-dimensional printing data according to claim 9, wherein the hollowing out the initial three-dimensional design model comprises:
performing bottom-through hollowing-out processing on the initial three-dimensional design model according to a preset hollowing-out wall thickness and preset precision when the three-dimensional application type is a bottom-located printing application type, adding a bottom plate to a bottom hollowed area of the initial three-dimensional design model after the bottom-through hollowing-out processing to obtain a hollowed three-dimensional model; and
performing closed hollowing-out processing on the initial three-dimensional design model according to a preset hollowing-out wall thickness and preset precision when the three-dimensional application type is a suspension printing application type to obtain a hollowed three-dimensional model.

12. The method for preprocessing three-dimensional printing data according to claim 3, wherein the support adding comprises:
obtaining a suspension point and a preset support adding area of the initial three-dimensional design model; and
additionally arranging support structures at the suspension point and the preset support adding area.

13. The method for preprocessing three-dimensional printing data according to claim 3, wherein the slicing comprises:
dividing the initial three-dimensional design model into a plurality of slice images according to a preset slice parameter.

14. The method for preprocessing three-dimensional printing data according to claim 13, wherein the preset slice parameter comprises a preset slice layer thickness and a preset image resolution, and the preset image resolution is obtained according to a size of a molding platform;
and/or the slicing further comprises:
preforming an edge processing on the slice image.

15. The method for preprocessing three-dimensional printing data according to claim 3, wherein the typesetting comprises:
obtaining a first preset distance value between models, and a second preset distance value between a model and an edge of a design layout corresponding a printing platform;
obtaining a plurality of typesetting solutions according to the first preset distance value, the second preset distance value and a size of a printing platform;
determining a typesetting solution with the most models from the typesetting solutions as a target typesetting solution; and
adjusting a position and a posture of the initial three-dimensional design model according to the target typesetting solution.

16. The method for preprocessing three-dimensional printing data according to claim 3, wherein the editing comprises:
splitting the initial three-dimensional design model to obtain a plurality of split models; and
arranging connectors for the split models, wherein the connectors are used for connecting the printed split models.

17. The method for preprocessing three-dimensional printing data according to claim 2, wherein after the generating three-dimensional printing data according to the preprocessed three-dimensional design model, the method further comprises:
slicing the three-dimensional printing data, and generating slice data of the three-dimensional print data corresponding to slice layers.

18. The method for preprocessing three-dimensional printing data according to claim 1, matching corresponding preset processing flow according to the three-dimensional application type, comprising:
automatic processing is performed according to the preset processing flow corresponding to the three-dimensional application type, flows of different three-dimensional application types are corresponding to different processing modes, and the preset processing flows is added or deleted according to different requirements; wherein the preset processing flow comprises at least one of automatic repairing, automatic straightening, automatic hollowing out, automatic typesetting, automatic support adding, gum line identifying and jig adding;
wherein the method is applied to a dental field, the initial three-dimensional design model is a dental design model, and the three-dimensional application type is a dental application type;
a model contour feature is recognized to identify the dental application type corresponding to the dental design model; corresponding dental application type and the preset processing flow are scheduled to perform data processing.

19. An electronic apparatus, comprising a memory, a processor, and a computer program stored on the memory and runnable on the processor, wherein the processor implements steps of the method for preprocessing three-dimensional printing data when executing the computer program, the method for preprocessing three-dimensional printing data comprises:
obtaining an initial three-dimensional design model and a three-dimensional application type corresponding to the initial three-dimensional design model;
matching a corresponding preset processing flow according to the three-dimensional application type; and
performing data preprocessing on the initial three-dimensional design model according to the preset processing flow to obtain a preprocessed three-dimensional design model;
matching corresponding preset processing flow according to the three-dimensional application type, comprising:
automatic processing is performed according to the preset processing flow corresponding to the three-dimensional application type, flows of different three-dimensional application types are corresponding to different processing modes, and the preset processing flows is added or deleted according to different requirements; wherein the preset processing flow comprises at least one of automatic repairing, automatic straightening, automatic hollowing out, automatic typesetting, automatic support adding, gum line identifying and jig adding;
wherein the method is applied to a dental field, the initial three-dimensional design model is a dental design model, and the three-dimensional application type is a dental application type;
a model contour feature is recognized to identify the dental application type corresponding to the dental design model; corresponding dental application type and the preset processing flow are scheduled to perform data processing.

20. A digital operation platform, comprising a user side, a design side and a preliminary processing unit, wherein
the user side is configured to obtain three-dimensional scanning data of a target;
the design side is configured to receive the three-dimensional scanning data and generate an initial three-dimensional design model according to the three-dimensional scanning data; and
the preliminary processing unit is configured to generate a preprocessed three-dimensional design model according to the method for preprocessing three-dimensional printing data, the method for preprocessing three-dimensional printing data comprises:
obtaining an initial three-dimensional design model and a three-dimensional application type corresponding to the initial three-dimensional design model;
matching a corresponding preset processing flow according to the three-dimensional application type; and
performing data preprocessing on the initial three-dimensional design model according to the preset processing flow to obtain a preprocessed three-dimensional design model.
